(19) United States
(12) Patent Application Publication
(10) Pub. No.: US 2007/0172640 A1
(43) Pub. Date: Jul. 26, 2007

(54) Porous film and method for preparation thereof

(76) Inventors: Nobuharu Tahara, Osaka (JP); Yasuhiro Tomi, Osaka (JP); Hideto Matsuyama, Kyoto (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/587,786

(22) PCT Filed: Jan. 27, 2005
(86) PCT No.: PCT/JP05/01117

§ 371 Date: Jul. 28, 2006

(30) Foreign Application Priority Data
Jan. 30, 2004 (JP) 2004-023283

(51) Int. Cl. B32B 3/26; H01M 2/16; C08K 3/34

(52) U.S. Cl. 428/319.1; 429/251; 524/445

(57) ABSTRACT

A production method for preparing a porous film of a poly(vinylidene fluoride) based resin which has a microstructure providing a satisfactory mechanical strength and permeation performance and is improved in hydrophilic property, without the precise control of temperature before cooling, as well as a porous film prepared by the above method is provided. The above method for producing a porous film wherein a porous film of a poly(vinylidene fluoride) based resin is prepared by dissolving the poly(vinylidene fluoride) based resin in a poor solvent through heating to form a liquid raw material for a film, and then cooling the liquid raw material to bring about a phase separation is characterized in that an organized clay being organized by a hydrophilic compound is dispersed in said liquid raw material for a film in an amount of 1 to 25 parts by weight relative to 100 parts by weight of the poly(vinylidene fluoride) based resin.

### FIELD OF THE INVENTION

The present invention relates to a porous film of a poly(vinylidene fluoride) based resin produced by a so-called thermally induced phase separation method (TIPS method), and a production method thereof.

### BACKGROUND ART

Porous film separation is positioned as an important unit operation for many purposes such as separation, purification, condensation, and fractionation of substances. It can replace the conventional operations of solid/liquid separation including aggregation, precipitation, and sand filtration with a single operation of porous film filtration. Currently, ultra filter (UF) and micro filter (MF) are used for purification of water in rivers and lakes, and the demand and market therefore tends to increase principally in China and in the Middle East areas that suffer from water circumstance problems.

However, a problem involved in current separation films is durability to reverse-pressure cleaning (reverse cleaning) and chemical agent cleaning (chemical cleaning) of UF or MF for carrying out the operation for a long period of time. For this reason, a PVDF (poly(vinylidene fluoride)) porous film having an excellent chemical resistance and a high physical strength is nowadays attracting people's attention.

As a method for producing a PVDF porous film, a so-called wet-type film-forming method (non-solvent induced phase separation method) is generally carried out in which PVDF, various additives, and others are mixed and dissolved in a polar solvent such as dimethylacetamide to prepare a liquid raw material, followed by extruding the liquid raw material into a liquid such as water having a coagulation function. However, the wet-type film-forming method had a problem in terms of the mechanical strength of the porous film.

For this reason, a thermally induced phase separation method (TIPS method) is attempted that induces a phase separation phenomenon by temperature change. However, since poly(vinylidene fluoride) has a high crystallinity, crystallization occurs together with phase separation in a phase separation process, whereby the poly(vinylidene fluoride) will have a structure in which coarse spherical crystals are partially linked. This reversely generated a phenomenon of reduced strength as compared with the wet-type film-forming method. Therefore, a method is proposed in which a porous film with a network structure having an excellent mechanical strength by restraint of the coarse spherical crystals is obtained by cooling the kneaded mixture of the poly(vinylidene fluoride) and the diluent from a specific temperature range, that is set to be slightly lower than the homogeneous mixing temperature, in order to restrain the spherical crystals becoming coarse (for example, see Japanese Patent Application Laid-Open (JP-A) No. 11-319522).

However, with this method, fusion and kneading are carried out intentionally at a low temperature in order to restrain the generation of spherical crystals and to form a network structure, so that the melt viscosity will be high, thereby necessitating reduction of the polymer concentration to lower the viscosity depending on the extruder. Also, since the form of the porous film structure is keenly influenced by the melting temperature, a temperature management precision is highly demanded.

On the other hand, a hydrophobic polymer such as PVDF has a low hydrophilic property, so that when this is used as a separation film, there is raised a problem such that solid substances such as fine particles and protein contained in feed water tend to adhere onto the film surface and the adhering substancese can hardly be removed. For this reason, a method for hydrophilization of a PVDF porous film is proposed. There is known a method in which, after a PVDF porous film is wetted with a solvent, the resultant is brought into contact with a solution containing polyvinylpyrrolidone and a polymerization initiator, followed by heating to cross-link the polyvinylpyrrolidone (for example, see Japanese Patent Application Laid-Open (JP-A) No. 11-302438). However, with such a method that accompanies cross-linking or polymerization of a hydrophilic substance, the production steps will be complex, thereby raising problems such as being disadvantageous in terms of costs.

### DISCLOSURE OF THE INVENTION

### PROBLEMS TO BE SOLVED BY THE INVENTION

Therefore, an object of the present invention is to provide a production method for preparing a porous film of a poly(vinylidene fluoride) based resin which has a microstructure providing a satisfactory mechanical strength and permeation performance and is improved in hydrophilic property, without the precise control of temperature before cooling, as well as a porous film prepared by the above method.

### MEANS FOR SOLVING THE PROBLEMS

In order to achieve the aforementioned object, the present inventors have made an eager research on a hydrophilization process of a porous film made of a poly(vinylidene fluoride) based resin and the control of a microstructure, and have found out that the aforementioned object can be achieved by dispersing an organized clay into a liquid raw material at the time of forming a film by the thermally induced phase separation method, thereby completing the present invention.

Namely, the method of producing a porous film of the present invention is a method for producing a porous film wherein a porous film of a poly(vinylidene fluoride) based resin is prepared by dissolving the poly(vinylidene fluoride) based resin in a poor solvent through heating to form a liquid raw material for a film, and then cooling the liquid raw material to bring about a phase separation, characterized in that an organized clay being organized by a hydrophilic compound is dispersed in said liquid raw material for a film in an amount of 1 to 25 parts by weight relative to 100 parts by weight of the poly(vinylidene fluoride) based resin.

With respect to the control of the structure of a porous film in the thermally induced phase separation method, in the case of a poly(vinylidene fluoride) based resin, in order to form a structure in which irregularly shaped resin phases are linked like a network, precise control of the melting temperature of the poly(vinylidene fluoride) based resin has been necessary, as disclosed in W099/47593 Gazette. Typically, this temperature is set to be a little lower than the complete homogeneous melting temperature. It seems that a phenomenon of formation of a microstructure in which resin phases are linked in a three-dimensional manner occurs by melting at a little low temperature of a specific range so that the crystals may not grow coarse more than needed in a crystal growth process accompanying the cooling. In the present invention, by dispersing an organized clay homogeneously in a molten liquid raw material, a microstructure can be formed having an irregularly shaped resin phase continuous in a three-dimensional manner and having irregularly shaped pore spaces therebetween, by cooling from an arbitrary melting temperature. With this microstructure, a satisfactory mechanical strength and permeation performance can be obtained by the continuous pore spaces and the continuous resin phase. Moreover, with use of the organized clay by a hydrophilic compound, a porous film of a poly(vinylidene fluoride) based resin with an improved hydrophilic property can be obtained.

It is preferable that the temperature of said liquid raw material for a film before cooling is 170° C. or above and lower than the thermal decomposition temperature of the poly(vinylidene fluoride) based resin. With this temperature range, the poly(vinylidene fluoride) based resin can be dissolved as a homogeneous phase, and the resin phase or the resin-concentrated phase is less liable to give an influence on the microstructure of the porous film, so that the control of the microstructure by the organized clay can be carried out with a higher precision.

On the other hand, the porous film of the present invention is a porous film comprising a poly(vinylidene fluoride) based resin and an organized clay being organized by a hydrophilic compound, the organized clay being dispersed therein in an amount of 1 to 25 parts by weight relative to 100 parts by weight of the poly(vinylidene fluoride) based resin, wherein a microstructure is formed by a thermally induced phase separation method, said microstructure having an irregularly shaped resin phase continuous in a three-dimensional manner and having irregularly shaped pore spaces therebetween.

When a porous film is formed by the wet-type film-forming method (non-solvent induced phase separation method) so as to attain nano dispersion of an organized clay in a poly(vinylidene fluoride) based resin, a microstructure is formed such as a sponge structure in which pore spaces having a shape near to a spherical shape are continuous in a three-dimensional manner or a finger void structure having finger-shaped macrovoids, and moreover, a pore diameter may be considerably different between the site near the film surface and the inside of the film. For this reason, mechanical strength such as tensile strength is liable to be insufficient. In contrast, with the present invention, by having the above-described microstructure which is a characteristic of a porous film formed by the thermally induced phase separation method, the porous film will have a satisfactory mechanical strength and permeation performance. Moreover, since an organized clay being organized by a hydrophilic compound is dispersed, the porous film will have an improved hydrophilic property.

Also, it is preferable that said organized clay is a clay prepared by organizing a layered inorganic silicate with an alkylene oxide compound. Since such an organized clay-will have a suitable dispersion property and a crystal size as a nucleus at the time of crystallization in forming a film by the thermally induced phase separation method, a microstructure having an irregularly shaped resin phase continuous in a three-dimensional manner and having irregularly shaped pore spaces therebetween can be obtained with more certainty.

### BRIEF DESCRIPTION OF THE DRAWINGS

FIG. 1 is a scanning electron microscope (SEM) photograph of a cross section of the porous film obtained in Example 1.

FIG. 2 is a scanning electron microscope (SEM) photograph of a cross section of the porous film obtained in Comparative Example 1.

FIG. 3 is a scanning electron microscope (SEM) photograph of a cross section of the porous film obtained in Comparative Example 2.

FIG. 4 is a scanning electron microscope (SEM) photograph of a cross section of the porous film obtained in Comparative Example 4.

### BEST MODES FOR CARRYING OUT THE INVENTION

Hereafter, embodiments of the present invention will be described. First, a mechanism of dispersing an organized clay in the present invention will be described.

In dispersing a reinforcing molecule into a composite material, supposing that the dispersion can be attained at the size of the molecule (nano meter order) to increase the interfacial interaction, it is expected that a considerable improvement in the mechanical characteristics of the materials can be made or an unexpected new property will appear. As a characteristic of a polymer based nano composite reported so far, it is known that the mechanical and thermal properties are improved while the specific weight is almost the same as that of the original polymer, and also the functional properties such as flame retardancy, gas barrier property, and transparency are exhibited. Moreover, it gives an advantage in that it can be produced in a comparatively easy manner by using only existing substances as the materials.

By using this technique in order to solve the aforementioned problems, the present inventors have found out that the hydrophilic property of a porous film can be improved while retaining various properties of the materials by preparing an organized clay through modification of a layered inorganic silicate with hydrophilic alkylene oxide and dispersing this at a nano level into the, above-described hydrophobic polymer having a high functionality.

Generally, even if one attempts to disperse superfine particles into a matrix by simple stirring and kneading, the particles will be aggregated by the particle-to-particle interaction accompanying the interfacial energy increase, making the nano dispersion difficult. As representative methods for obtaining a composite material without aggregating the superfine particles, there may be raised:

1) Interlayer insertion method (Intercalation method)

2) In-Situ method

3) Superfine particles direct dispersion method and the like as examples. Among these, the most popularly used one is the interlayer insertion method. Smectite group clay minerals such as montmorillonite are layered compounds, where the layers are charged with negative electricity, and there are cations between the layers in order to compensate for this. When these cations are replaced with an onium salt such as quaternary ammonium salt, a layered inorganic compound can be modified into an organic compound.

As the interlayer insertion methods, there are a method (polymerization method after monomer insertion) in which this organized clay and a monomer are mixed so as to allow polymerization of the polymer, layer exfoliation of the clay, and dispersion of this into the polymer to proceed simultaneously, and a method (polymer insertion method) in which an organized clay and a polymer are mixed in a molten state or in a common solvent so as to allow layer exfoliation of the clay and dispersion into the polymer to take place. The former method is known as a method of producing a nylon-clay hybrid (NCH) that has been made practically usable for the first time in the world. The latter method is simpler and more convenient; however, it is generally assumed to be difficult to obtain a nano composite in which the clay is subjected to complete layer exfoliation. However, in recent years, there are reported examples in which polymer based nano composites have been obtained such as a fluorine based polymer nano composite of Toyota Central Research and Development Laboratories (Japanese Patent Application Laid-Open (JP-A) No. 2000-204214) and a thermoplastic composite material of SEKISUI CHEMICAL CO., LTD. (Japanese Patent Application Laid-Open (JP-A) No. 2001-26724).

As the simplest technique, in a thermally induced phase separation method of dissolving a resin in a poor solvent through heating, to form a liquid raw material for a film, and then cooling the liquid raw material to bring about a phase separation, the present inventors have succeeded in obtaining a hydrophilized porous film that has been made into a nano composite, by dispersing an organized clay into the liquid raw material for a film.

Namely, the production method of the present invention is a method for producing a porous film wherein a porous film of a poly(vinylidene fluoride) based resin is prepared by dissolving the poly(vinylidene fluoride) based resin in a poor solvent through heating to form a liquid raw material for a film, and then cooling the liquid raw material to bring about a phase separation, wherein an organized clay being organized by a hydrophilic compound is dispersed in said liquid raw material for a film.

The organized clay to be used can be a commercially available one or can be obtained by ion exchange method or the like. Specifically, for example, while stirring and dispersing a clay such as Na-montmorillonite into hot water, a solution of a hydrophilic compound (onium ion or the like) obtained by allowing an amine compound having a hydrophilic group to react with hydrochloric acid or the like is added into the aforementioned dispersion liquid, thereby to obtain an organized clay being organized by a hydrophilic compound.

A clay (clay mineral) is a silicate mineral or the like having a layered structure, and is a substance having a layered structure in which numerous sheets (some are tetrahedral sheets constructed with silicic acid and some are octahedral sheets containing Al, Mg, or the like) are laminated. The layered structure made of these sheets, the kinds of the elements constituting the sheets, and the like are varied depending on the individual clays.

Specific examples of the clays to be organized include smectite type clay minerals such as montmorillonite, saponite, hectolite, beidellite, stevensite, and nontronite, vermiculite, halloysite, and swelling mica. These may be natural ones or synthesized ones. Among these, a layered inorganic silicate is preferable.

A hydrophilic compound can be used for organization of the above clay. The hydrophilic compound is preferably one that forms an ionic bond (ion exchange) with the clay, and is preferably an organic onium ion having a hydrophilic group such as an ammonium ion or phosphonium ion. The hydrophilic group is preferably an oxyalkylene group such as oxymethylene group, oxyethylene group, or oxypropylene group, or the like. Specifically, for example, hexylammonium ion, octylammonium ion, or the like can be used as the organic onium ion.

The size of the grains of organized clay is preferably 0.01 to 0.3 μm, more preferably 0.03 to 0.1 μm as an average particle size that is measured by SEM or TEM. When the organized clay is smaller than 0.01 μm, there is a possibility that the clay serving as a crystal nucleus may be dropped off. When the organized clay is larger than 0.3 μm, there is a possibility that the clay serving as a crystal nucleus may not be dispersed homogeneously, thereby clogging the holes.

Also, examples of the poly(vinylidene fluoride) based resin include copolymers containing vinylidene fluoride as a copolymerization component and blended products containing poly(vinylidene fluoride) as a mixture component in addition to poly(vinylidene fluoride). Examples of other components include fluorine-containing monomers such as vinyl fluoride, tetrafluoroethylene, and hexafluoropropylene, and polymer components thereof, and in addition, vinyl based monomers such as ethylene and propylene, and polymer components thereof. The weight-average molecular weight of the poly(vinylidene fluoride) based resin is preferably 100,000 to 2,000,000 in view of the film forming property, the strength of the obtained porous film, and others.

The organized clay is used in an amount of 1 to 25 parts by weight, preferably 5 to 20 parts by weight, relative to 100 parts by weight of the poly(vinylidene fluoride) based resin. When the amount is less than 1 part by weight, the effect of hydrophilization process will be insufficient, and also the amount as a crystal nucleus will be insufficient, thereby being liable to form a spherical crystal structure. When the amount exceeds 25 parts by weight, there will be a large rise in the viscosity, thereby being disadvantageous in the film forming property. Also, the amount as a crystal nucleus will be too much, so that the network structure will be dense, thereby being liable to lower the permeation flow flux (flux).

Also, the organized clay being organized by a hydrophilic compound preferably has a good dispersion property to the diluent shown below without generation of precipitation even when being left to stand still for 24 hours. In order to achieve the present invention, it is preferable to select an organized clay having a dispersion property being compatible with a hydrophilic group.

In the present invention, the organized clay is dispersed in a liquid raw material for a film that has been obtained by dissolving a poly(vinylidene fluoride) based resin in a poor solvent through heating. Here, a method of dissolving the resin through heating after dispersing the organized clay in a poor solvent is effective in enhancing the dispersion property. As a method for dispersing the organized clay, supersonic wave dispersion, vibration dispersion, and the like are preferable. In dissolving the resin through heating, various kneading apparatus can be used.

The poor solvent to be used may be one that can deposit or gelate the poly(vinylidene fluoride) based resin through cooling. Specifically, it includes, as examples, one or more kinds among phthalic acid esters such as dimethyl phthalate, diethyl phthalate, dibutyl phthalate, and dioctyl phthalate, as well as benzoic acid esters, sebacic acid esters, adipic acid esters, trimellitic acid esters, phosphoric acid esters, and ketones. Also, a mixed solvent can be used which is obtained by mixing a good solvent such as acetone, tetrahydrofuran, methyl ethyl ketone, dimethylformamide, dimethylacetamide, dimethyl sulfoxide, or N-methylpyrrolidone, or a non-solvent such as water into this single solvent or mixed solvent, and adjusting the solubility to such a degree as to form a solvent that can form a porous film.

Typically, the resin-concentration in the liquid raw material for a film is preferably 10 to 50 wt %. When the resin concentration exceeds 50 wt %, the viscosity of the liquid raw material for a film will be too high, so that it will be difficult to form a film, and also the porosity of the porous film tends to be low. On the other hand, when the resin concentration is smaller than 10 wt %, the mechanical strength of the obtained porous film tends to be deficient.

Also, the heating temperature at the time of melting and kneading may be above or equal to the temperature at which the poly(vinylidene fluoride) based resin is melted in a state of being mixed with a poor solvent, and further be below or equal to the temperature at which the poly(vinylidene fluoride) based resin is thermally decomposed. Preferably, the temperature of the liquid raw material before cooling is above or equal to 170° C. and below the thermal decomposition temperature of the poly(vinylidene fluoride) based resin.

In the present invention, various additives such as an antioxidant, ultraviolet absorber, lubricant, antiblocking agent, and the like can be added to the liquid raw material for a film in accordance with the needs within a range that does not deteriorate the purpose of the present invention.

In the present invention, such a liquid raw material for a film is cooled for phase separation, so as to obtain a porous film of poly(vinylidene fluoride) based resin. Specifically, for example, the liquid raw material after kneading is put into a cooling liquid such as water from arbitrary solving temperature (or melting temperature), or is cooled by a cooling roller or the like, for phase separation to form a porous structure. The temperature of the cooling liquid or the like is determined by the setting of the cooling speed; however, the cooling temperature is preferably −5 to 60° C., more preferably 0 to 40° C.

As the cooling liquid, non-solvents such as water, poor solvents such as phthalic acid esters, benzoic acid esters, sebacic acid esters, adipic acid esters, trimellitic acid esters, phosphoric acid esters, and ketones, and liquid mixture of a poor solvent and a non-solvent can be used. By using a poor solvent or a liquid mixture with a non-solvent as a cooling liquid, the surface structure of the obtained porous film can be approximated to the inner structure.

Subsequently, it is preferable to clean the poor solvent with an alcohol or acetone, so as to remove the poor solvent. Thereafter, the porous film is dried in accordance with the needs. The drying method may be, for example, drying by heating, drying with hot air, or a method of bringing into contact with a heating roll.

At the time of the above, the poor solvent may be removed without stretching; however, the stretching may be carried out before removing the poor solvent, or the stretching may be carried out after removing the poor solvent. The stretching is carried out at a predetermined magnification by an ordinary tenter method, roll method, rolling method, or a combination of these methods. The stretching may be either monoaxial stretching or biaxial stretching. In the case of biaxial stretching, it may be either lateral-longitudinal simultaneous stretching or successive stretching. The stretching temperature is preferably 50° C. or below, more preferably 25° C. or below.

Further, a thermal treatment can be performed on the porous film for the purpose of achieving stability of the dimension or the like. The thermal treatment temperature can be set at an arbitrary temperature which is above or equal to 50° C. and below or equal to the melting temperature of the poly(vinylidene fluoride) based resin −20° C. Also, hydrophilization treatment can be performed in accordance with the needs by alkali treatment, plasma radiation, electron beam radiation, γ-ray radiation, corona treatment, impregnation with a surfactant, surface grafting, coating, or the like. Further, cross-linking can be performed in accordance with the needs by electron beam radiation or γ-ray radiation.

The porous film of the present invention is suitably obtained by a production method such as described above, and is a porous film comprising a poly(vinylidene fluoride) based resin and an organized clay being organized by a hydrophilic compound, the organized clay being dispersed therein in an amount of 1 to 25 parts by weight relative to 100 parts by weight of the poly(vinylidene fluoride) based resin, wherein a microstructure is formed by a thermally induced phase separation method, said microstructure having an irregularly shaped resin phase continuous in a three-dimensional manner and having irregularly shaped pore spaces therebetween.

The porous film of the present invention preferably has an average pore diameter of 0.1 to 8 μm, particularly 0.2 to 3 μm, as measured by the scanning-type electron microscope (SEM) observation. Also, the porosity as determined from the bulk density is preferably 50 to 90%, particularly 60 to 80%.

The porous film of the present invention can be used for removal of bacteria, removal of turbidity, and removal of protein in an alcoholic drink or fruit juice drink in a food industry; production of superpure water in a semiconductor production industry; production of sterile water in a pharmaceutical industry; removal of turbidity in various kinds of industrial exhaust water, exhaust water from architectures such as a building, and sewage water; preprocessing of desalination by a method of reverse osmosis of river water, brine, and sea water; or the like, and can provide a porous separation film for microfiltration or ultrafiltration being excellent in mechanical strength. Also, it can be used for various purposes such as a separator for a battery, a separator for an electrolytic capacitor, and an electrolyte supporter for a solid electrolytic cell as well.

### EXAMPLES

Hereafter, Examples and the like specifically showing the construction and the effects of the present invention will be described.

Here, measurements were carried out setting the evaluation items in the Examples and the like as follows.

(Contact Angle)

By a generally used method, 5 μL of water droplets were quietly dropped onto a porous film, and the contact angle between the porous film and the water droplets were measured at the time point of 30 seconds after the dropping.

(Amount of Permeated Water)

Pure water was supplied from the inner surface side of a hollow thread porous film by pressurization (0.1 MPa), and the amount of water permeated to the outer surface side per constant period of time was measured.

(Tensile Strength, Elongation)

Stretching was carried out using an autograph manufactured by Shimadzu Corporation under the condition with a tensile strength of 100 mm/min, and the strength and the elongation at the time of breakage were measured.

(Structure Observation)

Measurement was carried out with a scanning-type electron microscope (SEM) photograph of the cross section of a porous film.

(Average Pore Diameter and the Porosity)

The average pore diameter was measured by scanning-type electron microscope (SEM) observation, and the porosity was calculated from the bulk density.

### Example 1

To 64 parts by weight of diethyl phthalate, 6 parts by weight of organized clay (SPN manufactured by Co-op Chemical Co., Ltd.) obtained by organization of a layered inorganic silicate with an alkylene oxide compound was added and dispersed by agitation for 4 hours at room temperature with a stirring blade at a speed of 3000 rpm while imparting a supersonic wave. Subsequently, 30 parts by weight of poly(vinylidene fluoride) (manufactured by Solvay Co., Ltd., SOLEF6020) were added, and the mixture was kneaded at 180° C. for 15 minutes at 50 rpm. After kneading, the resultant was temporarily cooled to room temperature to form a liquid raw material for a film. Thereafter, the prepared liquid raw material for a film was heated to 180° C. for homogeneous re-dissolution, pressed into a flat film having a thickness of 200 μm by pressurization, and put into a water bath of 5° C. for cooling to form a porous film. This porous film had an average pore diameter of 0.1 μm and a porosity of 64%.

### Example 2

A porous film was obtained through an operation similar to that of Example 1 except that the blending ratio of the liquid raw material for a film was set to be 2 parts by weight of organized clay, 58 parts by weight of diethyl phthalate, and 40 parts by weight of poly(vinylidene fluoride). This porous film had an average pore diameter of 0.1 μm and a porosity of 65%.

### Comparative Example 1

A porous film was obtained through an operation similar to that of Example 1 except that the blending ratio of the liquid raw material for a film was set to be 70 parts by weight of diethyl phthalate and 30 parts by weight of poly(vinylidene fluoride). This porous film had a porosity of 68%.

### Comparative Example 2

A porous film was obtained through blending and an operation similar to those of Example 1 except that the organized clay was changed to a non-hydrophilic clay (SAN manufactured by Co-op Chemical Co., Ltd.). This porous film had an average pore diameter of 0. 1 μm and a porosity of 63%.

### Example 3

By the method of Example 1, 1.5 parts by weight of organized clay (SPN manufactured by Co-op Chemical Co., Ltd.) obtained by organization of a layered inorganic silicate with an alkylene oxide compound, 68.5 parts by weight of diethyl phthalate, and 30 parts by weight of poly(vinylidene fluoride) were kneaded to obtain a liquid raw material for a film. This liquid raw material for a film was heated to 180° C. again and extruded into a cooling water tank, which had been regulated to have a temperature of 5° C., through a double-ring nozzle at 0.2 m/min using diethyl phthalate of 180° C. as a core liquid, so as to obtain a hollow porous film having an outer diameter of 1.0 mm and an inner diameter of 0.7 mm. The height from the nozzle to the cooling water tank was set to be 2 cm. This porous film had an average pore diameter of 0.1 μm and a porosity of 65%.

### Comparative Example 3

A hollow porous film was obtained through an operation similar to that of Example 3 except that the blending ratio of the liquid raw material for a film was set to be 70 parts by weight of diethyl phthalate and 30 parts by weight of poly(vinylidene fluoride). This porous film had a porosity of 68%.

### Comparative Example 4

To 68.5 wt % of dimethylacetamide, 5 wt % of organized clay (manufactured by Co-op Chemical Co., Ltd., SEN-c3000s) was added, and the mixture was stirred for 4 hours at room temperature with a stirrer at a speed of 3000 rpm while imparting a supersonic wave. Subsequently, after 14 wt % of poly(vinylidene fluoride) (KFW-1100 manufactured by Kureha Chemical Industry Co., Ltd.), 10 wt % of polyvinylpyrrolidone, and 2.5 wt % of water were added to this, dissolution was carried out for 3 hours at a temperature of 80° C. with a stirrer at a speed of 300 rpm while imparting a supersonic wave, so as to obtain a homogeneous liquid raw material for a film. This was cast onto a glass plate with an applicator, and it was immersed into hot water of 45° C. which is a non-solvent, so as to carry out phase separation and desolvation, followed by drying. The obtained porous film had a thickness of 50 μm, an average pore diameter of 2 μm, and a porosity of 68%. Also, the tensile strength was 20.5 kgf/cm², and the elongation was 220%.

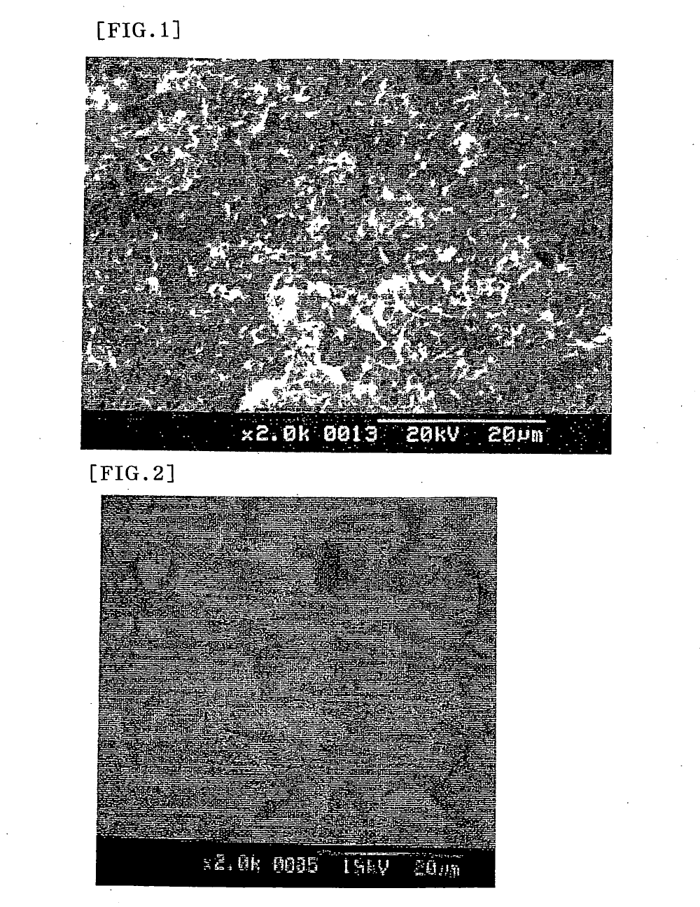

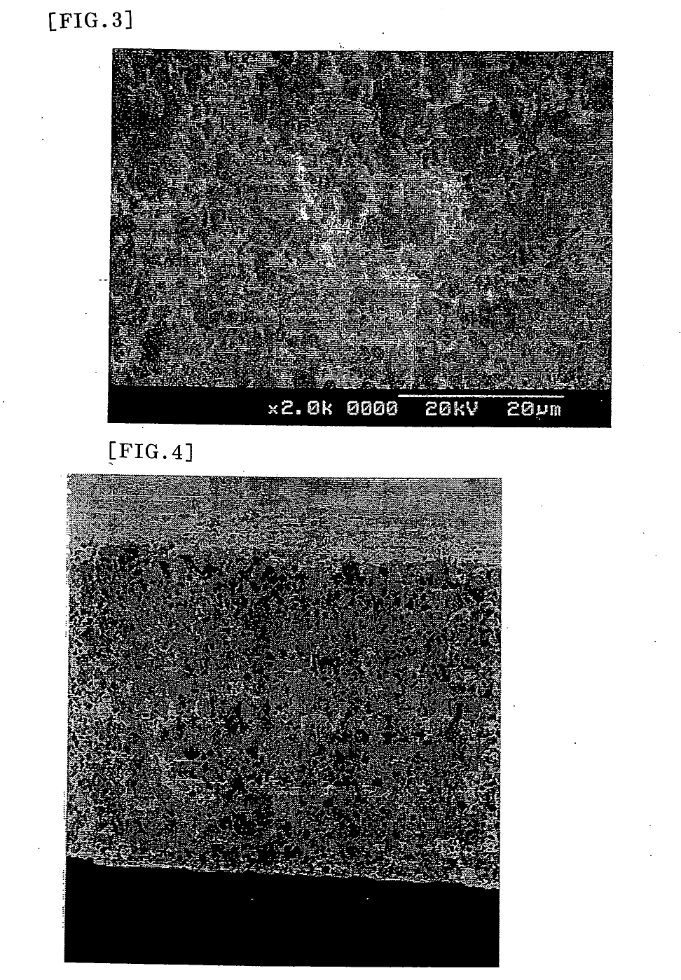

The results of carrying out the above evaluation by using the porous films described above are shown in Tables 1 and 2. Also, electron microscope photographs of the cross sections of the porous films obtained in Example 1, Comparative Example 1, Comparative Example 2, and Comparative Example 4 are shown in FIGS. 1 to 4.

TABLE 1

| | Contact | |
|---|---|---|
| | angle | Microstructure |
| Example 1 | 85° | Irregularly shaped |
| Example 2 | 100° | Irregularly shaped |
| Comparative | 120° | Spherical crystal of 3 μm or |
| Example 1 | | larger |
| Comparative | 118° | Irregularly shaped |
| Example 2 | | |

TABLE 2

| | Amount of | | | |
|---|---|---|---|---|
| | permeated | | | |
| | water | Tensile | | Contact |
| | L/m2 · h · kg | strength | Elongation | angle |
| | f/cm² | kg f/cm² | % | ° |
| Example 3 | 450 | 50 | 160 | 95 |
| Comparative | 480 | 23 | 110 | 113 |
| Example 3 | | | | |

From the results of Table 1, it will be understood that, when an organized clay being hydrophilic and having a good dispersion property is used, the hydrophilic property will be improved, and also a microstructure will be obtained having an irregularly shaped resin phase continuous in a three-dimensional manner and having irregularly shaped pore spaces therebetween (See FIG. 1). On the other hand, when clay is not used (Comparative Example 1), the hydrophilic property is not improved, and the structure was a spherical crystal structure (See FIG. 2). Also, when a clay being not hydrophilic though having a good dispersion property is used (Comparative Example 2), it will be understood that improvement in the hydrophilic property cannot be achieved.

From the results of Table 2, by using an organized clay being organized by a hydrophilic compound, improvement in the mechanical characteristics and the hydrophilic property was achieved. Also, the porous film of Comparative Example 4 obtained by the non-solvent induced phase separation method, though having a different film shape, was inferior in the mechanical characteristics as compared with Example 3.

1. A method for producing a porous film wherein a porous film of a poly(vinylidene fluoride) based resin is prepared by dissolving the poly(vinylidene fluoride) based resin in a poor solvent through heating to form a liquid raw material for a film, and then cooling the liquid raw material at temperature of 170° C. or above to bring about a phase separation, characterized in that an organized clay being organized by a hydrophilic compound is dispersed in said liquid raw material for a film in an amount of 1 to 25 parts by weight relative to 100 parts by weight of the poly(vinylidene fluoride) based resin.

2. The method for producing a porous film according to claim 1, wherein the temperature of said liquid raw material for a film before cooling is 170° C. or above and lower than the thermal decomposition temperature of the poly(vinylidene fluoride) based resin.

3. A porous film comprising a poly(vinylidene fluoride) based resin and an organized clay being organized by a hydrophilic compound, the organized clay being dispersed therein in an amount of 1 to 25 parts by weight relative to 100 parts by weight of the poly(vinylidene fluoride) based resin, wherein a microstructure is formed by a thermally induced phase separation method of cooling the liquid raw material at temperature of 170° C. or above to bring about a phase separation, said microstructure having an irregularly shaped resin phase continuous in a three-dimensional manner with a network structure and having irregularly shaped pore spaces therebetween.

4. The porous film according to claim 3, wherein said organized clay is a clay prepared by organizing a layered inorganic silicate with an alkylene oxide compound.

5. The method for producing a porous film according to claim 1, wherein said organized clay is a clay prepared by organizing a layered inorganic silicate with an alkylene oxide compound.

6. The porous film according to claim 3, wherein the temperature of said liquid raw material for a film before cooling is 170° C. or above and lower than the thermal decomposition temperature of the poly(vinylidene fluoride) based resin.

7. The method for producing a porous film according to claim 1, wherein said porous film comprises a microstructure having an irregularly shaped resin phase continuous in a three-dimensional manner with a network structure and having irregularly shaped pore spaces therebetween.

8. The method for producing a porous film according to claim 1, wherein said organized clay is a clay prepared by organizing a layered inorganic silicate with a hydrophilic compound, wherein said hydrophilic compound is an organic onium ion.

9. The method for producing a porous film according to claim 1, wherein said poor solvent comprises a phthalic acid ester.

10. The method for producing a porous film according to claim 1, wherein said porous film has an average pore diameter of 0.1 to 8 μm.

11. The porous film according to claim 3, wherein said porous film has an average pore diameter of 0.1 to 8 μm.

12. The method for producing a porous film according to claim 1, wherein said porous film has a porosity of 50 to 90%.

13. The porous film according to claim 3, wherein said porous film has a porosity of 50 to 90%.
